(19) United States
(12) Patent Application Publication
(10) Pub. No.: US 2008/0060005 A1
(43) Pub. Date: Mar. 6, 2008

(54) User-selectable audio feed for video programming

(76) Inventors: David E. Shanks, Los Angeles, CA (US); David E. Feldstein, Santa Monica, CA (US); Richard F. Purpura, Orange, CA (US); Matthew J. Thompson, Torrance, CA (US); Mark A. Shurgot, Los Angeles, CA (US)

Correspondence Address: THE DIRECTV GROUP, INC.;PATENT DOCKET ADMINISTRATION, CA / LA1 / A109, P O BOX 956, EL SEGUNDO, CA, 90245-0956, US

(21) Appl. No.: 11/824,664

(22) Filed: Jul. 2, 2007

Related U.S. Application Data
(60) Provisional application No. 60/817,776, filed on Jun. 30, 2006.

(51) Int. Cl. G06F 3/00

(52) U.S. Cl. 725/38

(57) ABSTRACT

An interactive matrixed video channel displayed on a video monitor. A channel in accordance with the present invention has a plurality of individual video feeds being presented at a given time and comprises a plurality of video cells presenting at least video information, each video cell associated with one of the plurality of individual video feeds, each video cell further comprising an area within the video cell reporting data related to the video feed, and a cursor, which can be moved between the plurality of video cells, for selecting an audio program associated with a selected video cell, wherein the audio program is selected from a group comprising a broadcast audio program, a second audio program, and a live audio program.

### CROSS-REFERENCE TO RELATED APPLICATIONS

This application claims the benefit under 35 U.S.C Section 119(e) of U.S. Provisional Application Ser. No. 60/817,776, filed on Jun. 30, 2006, by David E. Shanks et al., entitled “USER-SELECTABLE AUDIO FEED FOR VIDEO PROGRAMMING,” which application is incorporated by reference herein.

### BACKGROUND OF THE INVENTION

1. Field of the Invention

The present invention relates generally to satellite video systems, and in particular, to a method, apparatus, and article of manufacture for a custom on-screen display for data presentation.

2. Description of the Related Art

Satellite broadcasting of communications signals has become commonplace. Satellite distribution of commercial signals for use in television programming currently utilizes multiple feedhorns on a single Outdoor Unit (ODU) which supply signals to up to eight IRDs on separate cables from a multiswitch.

FIG. 1 illustrates a typical satellite television installation of the related art.

System 100 uses signals sent from Satellite A (SatA) 102, Satellite B (SatB) 104, and Satellite C (SatC) 106 that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to monitor 114 for viewing by a user. There can be more than one satellite transmitting from each orbital location and additional orbital locations without departing from the scope of the present invention.

Satellite uplink signals 116 are transmitted by one or more uplink facilities 118 to the satellites 102-106 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Alternatively, uplink facilities 118 can send signals via cable 122 either in conjunction with uplink signals 116 or instead of uplink signals 116 to IRD 112, for display on monitor 114.

Each satellite 102-106 broadcasts downlink signals 120 in typically thirty-two (32) different frequencies, which are licensed to various users for broadcasting of programming, which can be audio, video, or data signals, or any combination. These signals are typically located in the Ku-band of frequencies, i.e., 11-18 GHz, or in the Ka-band of frequencies, i.e., 18-40 GHz, but typically 20-30 GHz.

As satellites 102-106 broadcast additional services and additional channels to viewers, viewers will like and expect to see programming on monitor 114 that relate to their specific needs and desires.

### SUMMARY OF THE INVENTION

To minimize the limitations in the prior art, and to minimize other limitations that will become apparent upon reading and understanding the present specification, the present invention discloses an interactive matrixed video channel displayed on a video monitor. A channel in accordance with the present invention has a plurality of individual video feeds being presented at a given time and comprises a plurality of video cells presenting at least video information, each video cell associated with one of the plurality of individual video feeds, each video cell further comprising an area within the video cell reporting data related to the video feed, and a cursor, which can be moved between the plurality of video cells, for selecting an audio program associated with a selected video cell, wherein the audio program is selected from a group comprising a broadcast audio program, a second audio program, and a live audio program.

Such an interactive matrixed video channel further optionally comprises the user selecting a video program associated with the selected video cell such that a secondary video cell is displayed, comprising at least the selected video program, the secondary video cell further comprising displaying at least the data related to the video information in the video feed, an overlay screen, which is selectively overlayed on at least one of the matrixed video channel and the secondary video cell, wherein the overlay screen comprises data related to the video information in the video feed, the overlay screen being displayed in response to a user selection on a remote control, the data related to the video feed toggles between an overall data display and a current data display, and the data toggles based on a user selection on a remote control.

An apparatus in accordance with the present invention displays a mosaic video channel, wherein the mosaic video channel has a plurality of video cells being presented at a given time, comprises a broadcast delivery system, comprising a transmitter and a receiver, a monitor, coupled to the receiver, for selectively displaying the mosaic video channel, each video cell associated with one of a plurality of individual video feeds, and a cursor, displayed on the monitor, which is movable between the plurality of video cells, for selecting an audio program associated with a selected video cell, wherein the audio program is selected from a group comprising a broadcast audio program, a second audio program, and a live audio program.

Such an apparatus further optionally comprises the broadcast delivery system being a satellite television delivery system, a plurality of mosaic video channels, when the user selects a video program associated with the selected video cell, a secondary video cell is displayed which comprises at least the selected video program, the secondary video cell further comprising displaying at least the data related to the video information in the video feed, an overlay screen, which is selectively overlayed on at least one of the matrixed video channel and the secondary video cell, wherein the overlay screen comprises data related to the video information in the video feed, and the overlay screen is displayed in response to a user selection on a remote control.

A system in accordance with the present invention selectively displays a video cell within a mosaic video channel having a plurality of video cells, and comprises a broadcast delivery system, comprising a transmitter and a receiver, a monitor, coupled to the receiver, for selectively displaying the mosaic video channel, each video cell associated with one of a plurality of individual video feeds, and a cursor, displayed on the monitor, which is movable between the plurality of video cells, for selecting an audio program associated with a selected video cell, wherein the audio program is selected from a group comprising a broadcast audio program, a second audio program, and a live audio program.

Such a system further optionally comprises the broadcast delivery system being a satellite television delivery system, when the user selects a video program associated with the selected video cell, a secondary video cell comprising at least the selected video program is displayed, the secondary video cell further comprises displaying at least the data related to the video information in the video feed, an overlay screen, which is selectively overlayed on at least one of the matrixed video channel and the secondary video cell, wherein the overlay screen comprises data related to the video information in the video feed, and the overlay screen is displayed in response to a user selection on a remote control.

Other features and advantages are inherent in the system disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation of the related art;

FIG. 2A illustrates a typical six-cell matrix with a generic video feed in accordance with the present invention;

FIG. 2B illustrates a remote control used in the present invention;

FIGS. 3A-3B illustrate on-monitor displays of a data presentation page in accordance with the present invention;

FIGS. 4A-4C illustrate data selection screens in accordance with an embodiment of the present invention; and

FIG. 5 illustrates a block diagram of the control for commercial spots in accordance with the present invention.

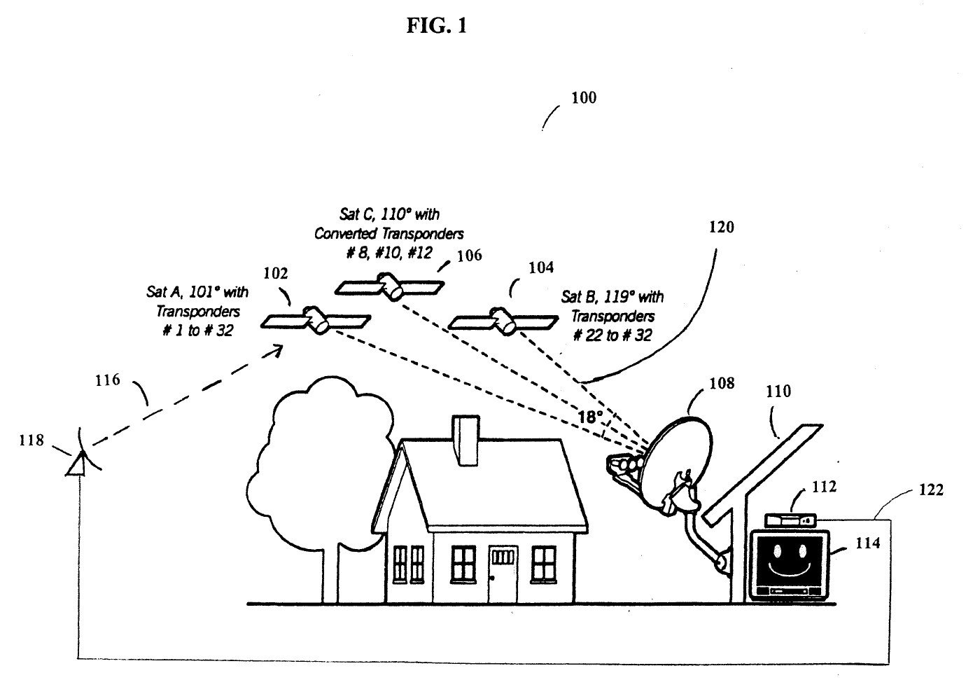

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Interactive Mosaic Channel Display Diagram

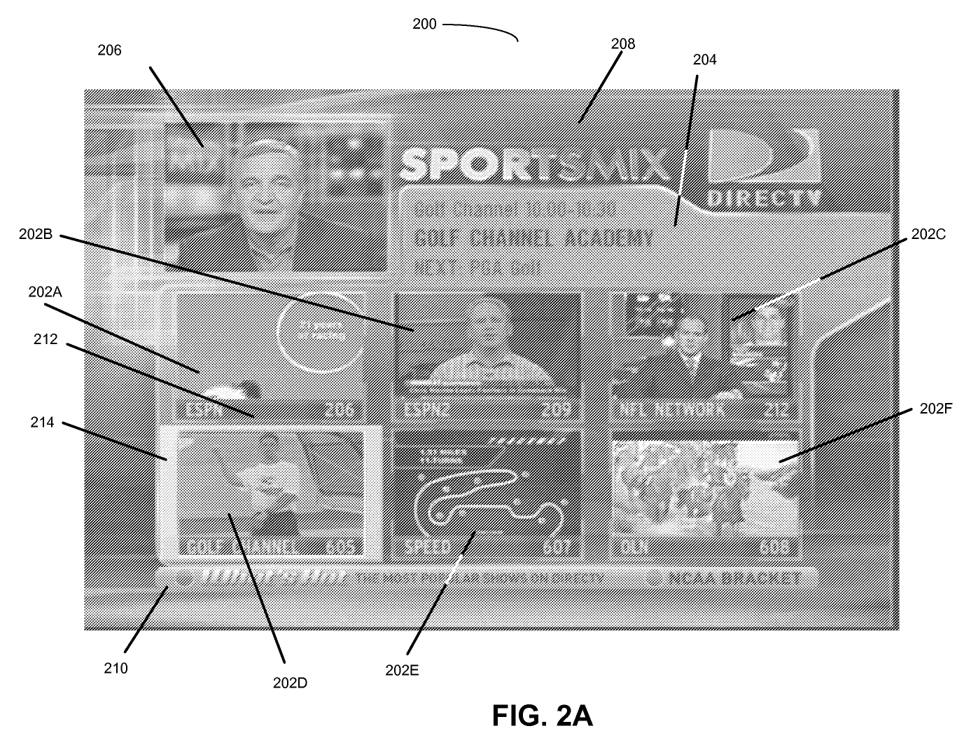

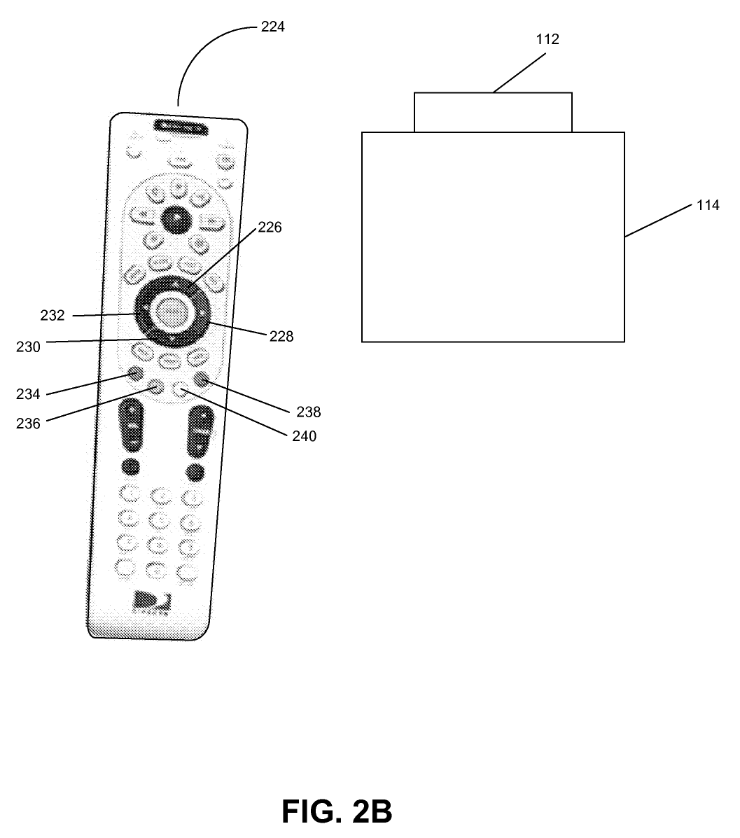

FIG. 2A illustrates a typical matrix with a generic video feed in accordance with the present invention.

Interactive mosaic channel 200 is shown as being displayed on monitor 114. Within interactive mosaic channel 200, there are a number of video cells 202A-202F and a text box 204, also referred to as an On Screen Display (OSD) 204. Optionally, the interactive mosaic channel 200 further comprises a separate video cell 206, also called a “barker cell” 206, a background video 208, and a control bar 210. The video cells 202A-F optionally comprise a channel identification (channel ID) portion 212. Further, cursor 214 is also optionally included to allow for interaction with each of the video cells 202A-202F and barker cell 206.

The number of video cells 202A-F can change based on the number of video cells 202 A-F desired. As the number of video cells 202A-F increases, of course, there must be a reduction in the size of the video cells 202A-F to ensure that the video cells are differentiated on the monitor 114. As the number of video cells 202A-F decreases, the size of the video cells 202A-F can increase, since there is more space available on monitor 114 to display video cells 202A-F.

Further, the placement of video cells 202A-F, barker cell 206, text box 204, and control bar 210 is not limited to the positions on monitor 114 as shown in FIG. 2A. These elements can be displayed anywhere on monitor 114 without departing from the scope of the present invention.

As there are multiple video feeds and video cell 202A-F and barker cell 206 being presented, each video cell 202A-F and barker cell 206, as well as background video 208 and possibly control bar 210, have associated audio portions that can be played. Presenting more than one audio stream may be confusing; as such, it is typical that only one audio stream of information is presented at a given time. However, each of the video feeds may also have closed-captioning information associated with it, and selection of a closed-captioned presentation, rather than an audio presentation, can be performed as described herein.

Video Cells

Video cells 202A-F each comprise a separate viewer channel of programming. So for example, in an interactive mosaic channel that is focused on news programming, cell 1 could contain the video programming associated with the viewer channel of FOX News Channel, cell 2 could contain the video programming associated with the viewer channel of CNN, cell 3 could contain the video programming associated with the viewer channel of Headline News, cell 4 could contain the video programming associated with the viewer channel of MSNBC, cell 5 could contain the video programming associated with the viewer channel of The Weather Channel, and cell 6 could contain the video programming associated with the viewer channel of C-SPAN. The placement and video programming content for each video cell 202A-F can depend on a wide variety of factors, such as Nielsen ratings for a given channel, whether a given channel is available on a specific viewer's programming package, viewer channel number (lowest to highest or highest to lowest) or can be decided or changed based on programming that is present on one or more of the viewer channels available for the interactive mosaic channel. For example, and not by way of limitation, an important vote on the floor of the Senate may be taking place, and a decision can be made to change the placement of C-SPAN from video cell 202F to video cell 202A for a period of time. Changes in presentation for the interactive mosaic channel 200 are discussed below.

Within each of the video cells 202A-F is a channel identification (ID) box 212. Typically, the channel ID box 212 indicates to the viewer the moniker or name that is associated with the video feed being shown in that respective video cell 202A-F, and the viewer channel number associated with the video feed being shown in that respective video cell 202A-F. For example and not by way of limitation, in video cell 202A, which as described above, is showing the video feed for ESPN, channel ID box 212 would indicate “ESPN” as well as, optionally, a channel number, e.g., “206” to indicate to the viewer that the video feed being shown in video cell 202A is that of ESPN, and that the viewer is accustomed to seeing this full-monitor 114 video programming on viewer channel 206.

Other information may also appear in channel ID box 212, such as an indication that the video feed that is being presented in the associated video cell 202A-F is a “user favorite” channel, the channel ID box 212 may be presented in a different color or video texture to indicate that the video feed that is being presented in the associated video cell 202A-F is a channel that presents programming that adults may wish to block from their children's view or has closed-captioning available, etc. Many possibilities are available within the scope of the present invention to present various types of video information within channel ID box 212 for viewer selection and benefit. The channel I) box 212 may also appear without a video cell 202A-F for those video feeds that are channel blocked via parental control, or otherwise unavailable to a specific viewer because of the viewer's programming package or other reasons.

Text Box

Text box 204 contains textual information that is useful to the viewer, and this information can change depending on the viewer's selection of interactive services as described herein. For example, the text box 204 can contain a generic statement about the genre of the interactive mosaic channel 200, or statements directed to a selected video cell 202A-F or information related to the channel ID box 212 to describe to a user the meaning of the information presented in the channel ID box 212 or other information related to the video cell 202A-F and channel ID box 212. The text box can also scroll to present additional information to the viewer that does not all fit within text box 204 at a given time.

There can also be default text associated with each interactive mosaic channel 200, and, depending on the capabilities of IRD 112, each time an interactive mosaic channel 200 is tuned to, a default descriptive text shall be displayed in the text box 204.

Barker Cell

Barker cell 206 is a presentation of video data that can relate to the video cells 202A-F that are present in interactive mosaic channel 200. For those interactive mosaic channels 200 that have the optional barker cell 206, the barker cell 206 can use audio or video clues to direct the user to one of the video cells 202A-F for more information on a given topic, or provide an overview of the information presented within the video cells 202A-F. For example, the audio and video associated with barker cell 206 in a news format can be a series of stories that are being covered in more depth on the viewer channels being shown in video cells 202A-F, and the barker cell 206 audio and video can then direct the viewer to tune the IRD 112 or monitor 114 to a specific video cell 202A-F for more information on that topic. The barker cell 206 can also be used to provide an overview of the news stories, either those presented in video cells 202A-F or other news stories of interest, without directing the viewer to one of the video presentations being discussed in the video feeds shown in video cells 202A-F.

Barker cell 206 can present audio and video information that is not available on any other viewer channel that is accessible to IRD 112 or monitor 114, other than within the barker cell 206 of the interactive mosaic channel 200. When the barker cell 206 presents audio and video information that is not present on any other viewer channel accessible to IRD 112 or monitor 114, then the barker cell 206 does not have an associated channel ID box 212.

Background Video

Background video 208 is typically a backdrop for the interactive mosaic channel 200. The background video 208 can be related to the genre of the interactive mosaic channel 200; for example, in a news environment, the background video 208 can be related to a top news story, the stock market exchange building, a prominent government building, etc. The background video 208 can be changed or can be a dynamic video depending on the desires of the editorial staff or viewer preferences. Further, the background video 208 can be a logo or other indicator of the source of the interactive mosaic channel 200, such as DIRECTV.

Interactive Features

FIG. 2B illustrates a remote control used in the present invention.

Typically, IRD 112 and monitor 114 are controlled by a remote control device 224, which allows viewers a convenient way to control audio volume, channel selection, and other features and display characteristics from a distance away from the IRD 112 and/or monitor 114.

Each video cell 202A-F has an associated channel ID box 212, and one of the video cells, cell 202D, has a cursor 214 surrounding that specific video cell 202 and, optionally, channel ID box 212. The cursor 214 indicates that the specific video cell 202 and channel ID 212 has been selected by the viewer. The cursor 214 is typically controlled by buttons 226-232, but can be controlled by other buttons on the remote control 224 if desired.

By selecting a given video cell 202A-F, the viewer is selecting a specific characteristic associated with that given video cell 202A-F, or associated video feed used to generate that video cell 202A-F. In most instances, when the viewer selects a given video cell 202, the audio portion associated with the selected video cell 202 will be presented to the viewer, rather than the audio portion associated with the barker cell 206 or a generic audio track that is associated with interactive mosaic channel 200. Further, selection of a given video cell 202A-F with cursor 214 may also select a closed captioning data stream associated with the selected video cell 202, depending on the availability of such a data stream and/or other settings that a viewer has selected. Cursor 214 can be moved to any of the video cells 202A-F, and, optionally, can be moved to select text box 204 or control bar 210.

When cursor 214 is moved to a given video cell 202A-F via buttons 226-232, text box 204 also may undergo a change in information. Typically, when the video cell 202A-F is selected by the viewer, indicated by the presence of cursor 214, text box 204 will present the information in the Advanced Program Guide (APG) that is associated with the viewer channel selected by cursor 214. The APG typically includes information on the program or “show” that is currently being presented by the viewer channel shown in video cell 202A-F, as well as the time that show is being aired and the next show to be aired on that viewer channel. Other information, either in the APG or external to the APG, can also be displayed in the text box 204 when the cursor is moved to a given video cell 202A-F.

As such, the viewer can “interact” with the interactive mosaic channel 200 and decide which audio track to listen to, find out a plot line of each of the shows being presented in the various video cells 202, find out what is going to be aired next in the various viewer channels being presented in video cells 202, or listen to generic audio from the barker cell 206 or associated with the interactive mosaic channel 200 itself while variously viewing the video presentations in the video cells 202. If a specific video cell 202 presents video information that is of interest to a viewer, then the viewer can move cursor 214, via a remote control command, to a given video cell 202, and listen to the audio associated with that video cell 202 and find out more about that viewer channel in text box 204.

If the viewer decides that the selected video cell 202 is of enough interest, the viewer can then directly tune to the selected video cell 202, i.e., tune directly to that viewer channel that is providing the video and audio used to create video cell 202, by pressing a single button on the remote control 224 (typically the “select” button on a DIRECTV remote control). This will tune the IRD 112 or monitor 114 to that viewer channel, which will then be presented full-screen to the viewer as in a normal television monitor 114 viewing format.

The barker cell 206, since it typically contains audio and video information that is not located on any viewer channel other than the interactive mosaic channel 200, cannot typically be selected for full screen viewing by the viewer on monitor 114. However, the barker cell 206 can be selected for full monitor 114 viewing, or at least enough of the monitor 114 to allow for changes in the video cells 202 as described below, to allow for changes in the interactive mosaic channel 200 and in the control bar 210 in near-real-time.

Control Bar

The Control Bar 210 (also called the Attract Icon or the Attract Icon Bar) The control bar 210 allows for instant, on-screen access to several data sources that allow the viewer to access data related to that being shown in the video cells 202A-F as well as other viewer channels available within system 100. Those IRDs 112 that have interactive capabilities have special buttons that correspond to the icons that appear on the control bar 210. Each icon/button directs the viewer to a different screen, such as special events, or, in the case of the present invention, data related to real-time or near-real-time viewership of channels within system 100. Each screen can have sub-screens that further allow related data to be viewed or otherwise analyzed by the viewer.

For example, and not by way of limitation, one of the remote control 224 buttons, e.g., the “red” button 234, indicated by text and/or graphics on control bar 210, may take a viewer to the “What's Hot” page, where viewers can review data related to viewership of shows currently being aired within system 100.

Similarly, a “special” page can be accessed by pressing a different button on the remote control 224, e.g., the “green” button 236, or the blue button 238 or yellow button 240, where viewers can view a channel or other data page. The special page can be reprogrammed by the system provider or the viewer based on time, or, in the case of interactive mosaic channel 200, can be done by genre. For example, and not by way of limitation, the special page can be assigned to the NCAA bracket for a “Sports” mosaic channel 200, and, if the viewer changes to a “News” mosaic channel 200, the special page can be a breaking news channel or news recap video loop that is provided by the system provider. There can be more than one special “page” that is accessible from the buttons 234-240, or other buttons on the remote control 224, if desired.

Sport Specific Application

Many sports are shown on monitor 114, and many sports have tournaments and/or events that are highlighted throughout each sport's season. The United States Open is America's premier televised tennis event. However, there are approximately 100 hours of live coverage on one or more broadcast networks covering any given sporting event, and, in the case of the U.S. Open, viewer choices are typically limited to a single match covered at any one time on one network. With live tennis action taking place simultaneously on up to 18 courts at once, there's often much more happening at the U.S. Open, typically held in Flushing Meadows, N.Y., than viewers get a chance to see.

The present invention expands coverage of a given sporting event by using existing production resources and interactive television technology to present a mix channel for viewing of such events. Each of the video cells 202 can have a unique live match presented therein, along with current game and/or match scores, and can be direct tuned via a cursor.

Each of the video cells 202 is moreover selectable, tuning to a full-screen Court Channel. Upon tuning to each Court Channel, the current Match Score (including Games, Sets, and Set Tiebreakers) can be shown on the full screen Court Channel, then transition to show just the Game Score. Viewers can also toggle between these score displays using a colored button. A half-screen Scoreboard overlay is also available via colored button press on both the Mix and Court Channels. A Control Bar can also be placed on the regular broadcast network channel, e.g., on the USA Network channel as well, indicating colored button links to both the Scoreboard overlay and the US Open Mix Channel.

On each of the Court Channels, commercial spot inventory can differ between channels based on direction from the broadcast network, agreement between the service provider and the broadcast network, or other means. Further, commercial advertising may change based on the play on each court.

Monitor Displays

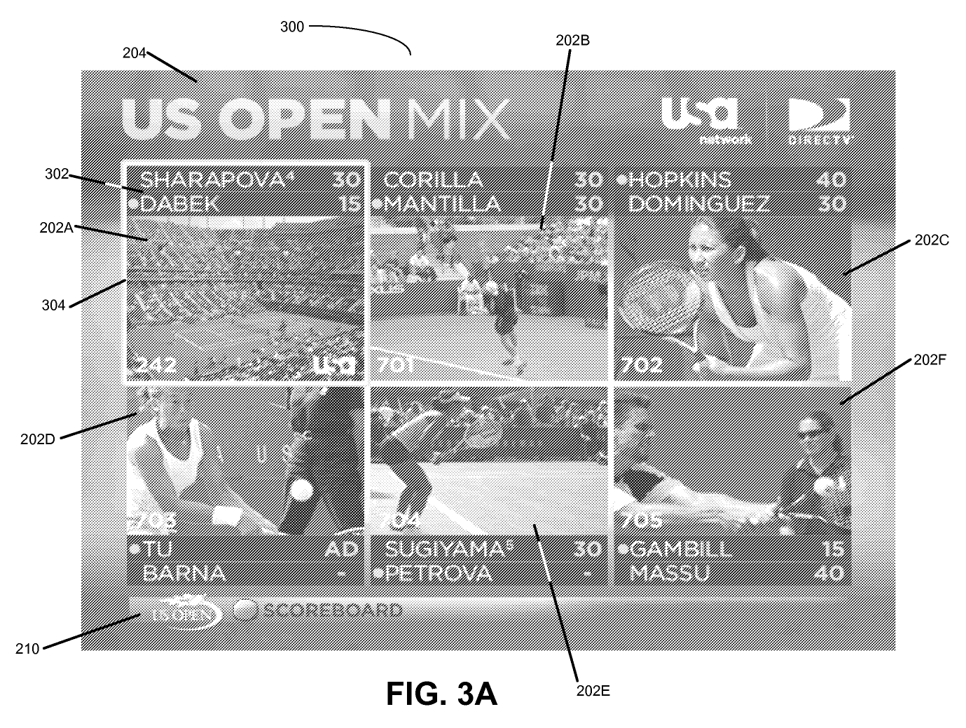

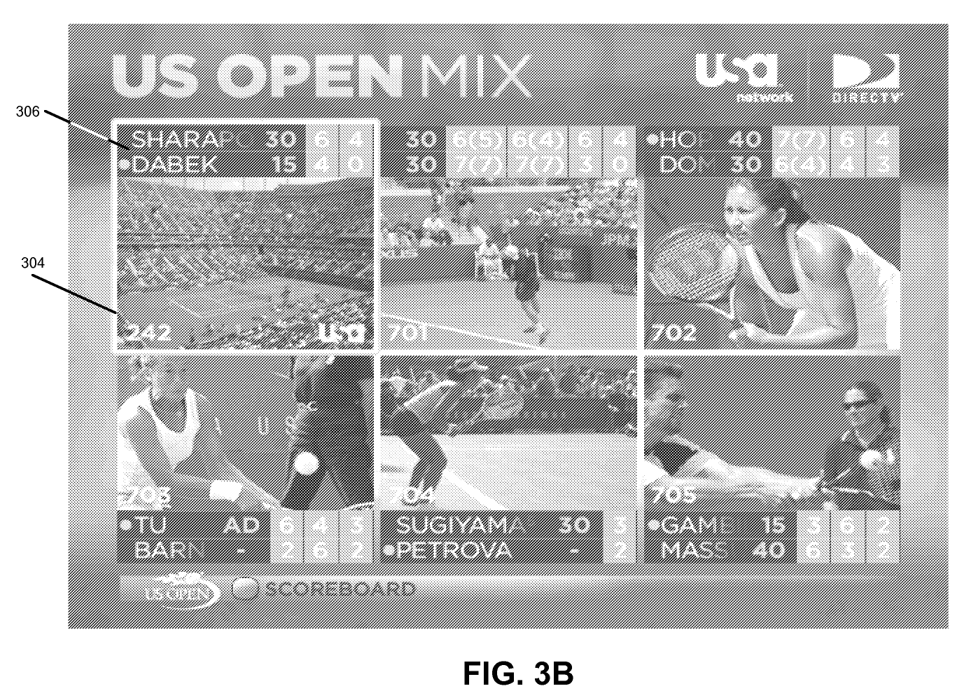

FIGS. 3A-3B illustrate on-monitor displays of data presentation pages in accordance with the present invention.

FIG. 3A illustrates Mix Channel screen 300, which comprises six video cells 202A-202F, text box 204, and control bar 210. Within video cells 202A-F, channel ID 212 is shown, along with data area 302.

For data area 304 of the video cells 202A-F, not only are scores indicated for each of the contested games, but the seeding of each player in a given match. The current leader in a given match can be indicated by a different color background, or different colored letters appearing within data area 304, or other visual indicators that would provide that information to a viewer. Further, when the game enters a critical point, such as a fifth set, a tie breaker, or other critical point, the score or background can be displayed with a different color or in bold, or other visual clues can be used within data area 304 or video cells 202A-F to indicate to the viewer that a critical point in the game has been reached. The viewer can then quickly determine whether the game that is at a critical junction should be viewed, which can be done by moving a cursor to the video cell 202A-F of interest and selecting that video cell, or whether the score, teams, or other issues associated with that game are not of interest to the viewer at that time. Further, cursor 304 indicates which video cell 202A-F is selected.

When selected via cursor 304, screen 300 can switch to several audio feeds associated with the video data. One of the audio feeds is, of course, the audio feed from the broadcast network, typically the announcers that are commentating on the match. If available, the Second Audio Program (SAP), which is typically announcers making the comments about the match in a different language, can also be selected. However, the present invention also allows for a third audio program to be accessed, namely, the sounds that are taking place on the court. So, for example, a user will have a choice of hearing the announcers, the SAP channel, or the natural court sounds without an announcer, if desired.

For example, and not by way of limitation, data area 302 can indicate match scores 306 as shown in FIG. 3B. The scores 306 can be displayed instead of the current match score, and such a display of scores 306 can occur upon pressing a button 234-240 on remote control 224, or upon switching screens 300, or upon other predetermined conditions.

The data within summary area 302 and data area 304 is typically maintained as live, up-to-the-minute data reports that provide current scores, times, and other data associated with either video cells 202 or other data that is typically related to video cells 202 by genre. Other indicators, such as that the game is completed, the game has not started, or there is a time-out in the match, are also possible displays of data within data area 304.

The availability window for the interactive features available via cursor 304 on the broadcast network will mirror the broadcast network's live coverage. Screen 300 (also called the Mix Channel) and the Court Channels, however, will continue to be available between the Day and Night US Open program blocks on the broadcast network, and will continue to be available at the end of the broadcast network's evening program block until the conclusion of all the covered matches. During these periods, the service provider can cease encoding the channels with USA's SID to preserve the integrity of the Nielsen rating for the non-event programming on the broadcast network. Such an approach can provide the broadcast network with a higher aggregated Nielsen rating for the televised event.

Typically, six video cells 202A-F will be used: the broadcast network feed plus five additional court feeds, however, other layouts for video cells 202 can be used without departing from the scope of the present invention. During portions of the event, e.g., for specific periods when fewer matches are taking place, a four-cell video cell 202 layout may be used instead, or merely 4 cells of the standard six-cell video cell 202 layout, with two other cells being dedicated to highlight video, behind-the-scenes news or information, or other related data to the sporting event. Further, other related events, e.g., doubles tennis matches, previous year's matches, etc. can be shown via the video cells 202.

Each court feed, i.e., video cell 202 video data, remains in its respective cell for the duration of the day. During breaks between matches, a locked off camera feed from that court can be shown if desired, or a static slide can replace the video data. If the action for a given court concludes before the end of USA's coverage, a static slide will replace the feed.

Court Channels

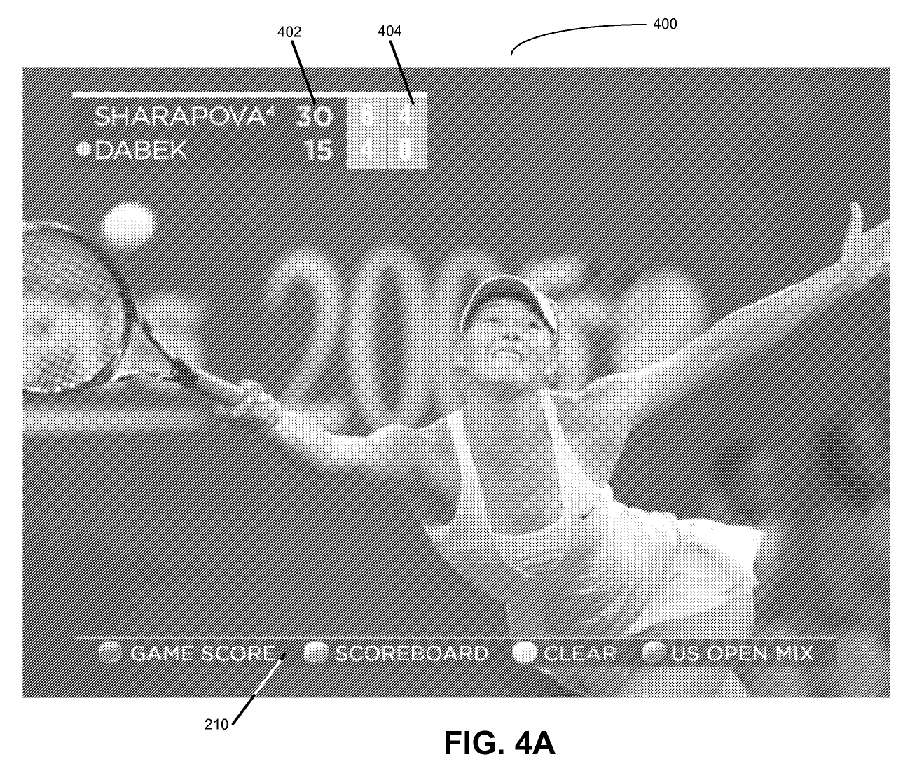

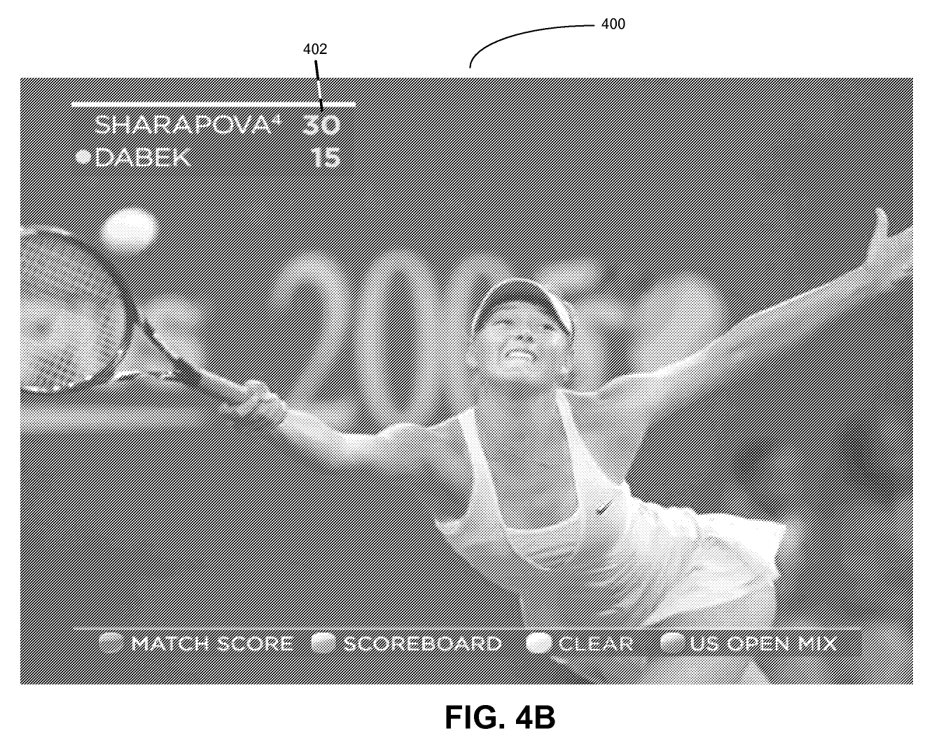

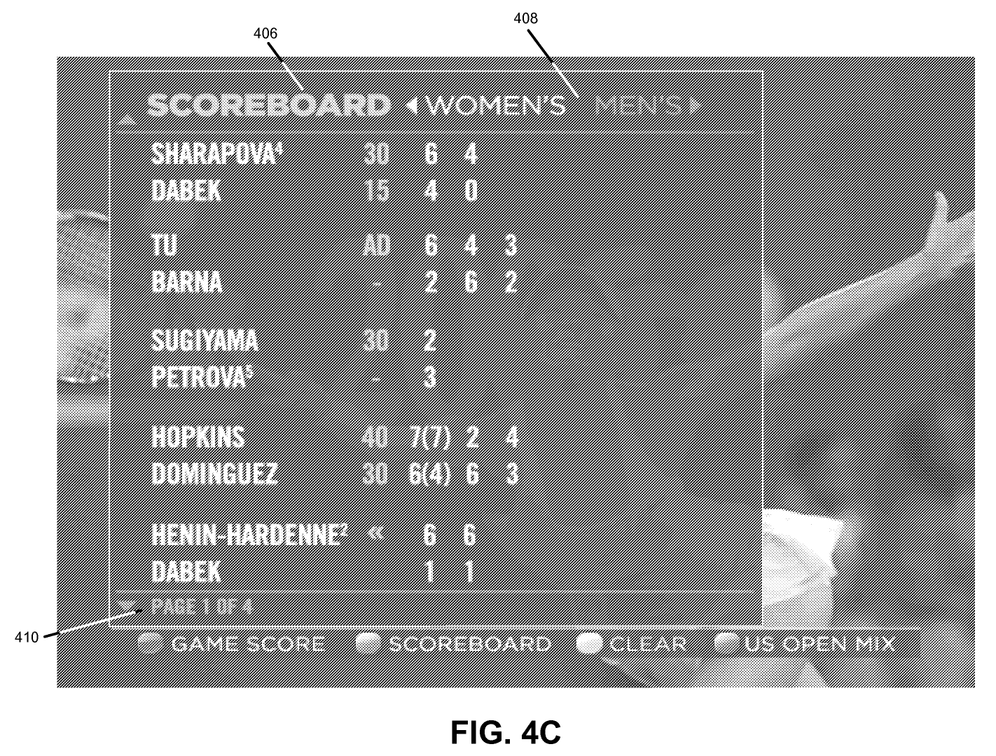

FIGS. 4A-4C illustrate individual court channels in accordance with the present invention.

As shown in FIG. 4A, screen 400 illustrates a view on monitor 114 after selection of one of the video cells 202A-F via cursor 304. The video data is taken to the full screen mode, with the score 402 of the current game and the match score 404 shown. Further, control bar 210 is also shown at the bottom of screen 400.

Within control bar 210, several indicators are shown, which correspond to the actions performed by IRD 112 when a given button 234-240 is pressed on remote control 224. For example, in FIG. 4A, control bar 210 shows that pressing red button 234 will remove the match score and show only the game score, pressing green button 236 will activate the scoreboard, pressing blue button 238 will return the viewer to the mix channel screen 300, and pressing yellow button 240 will remove the score 402 and/or match score 404 (if displayed on screen 400), and pressing yellow button 240 once more will remove control bar 210 from screen 400. Even if control bar 210 is not shown on screen 400, pressing any of buttons 234-240 will continue to perform the functions indicated.

When viewing either screen 300 or screen 400, the video cell 202 will periodically transition the score 302 (or 402 and 404) to indicate the full Match Score, i.e., the current and previous set scores, including any tiebreakers.

Further, as when screen 300 selects a video cell 202 via cursor 304, screen 400 can switch to several audio feeds associated with the video data. One of the audio feeds is, of course, the audio feed from the broadcast network, typically the announcers that are commentating on the match. If available, the Second Audio Program (SAP), which is typically announcers making the comments about the match in a different language, can also be selected. However, the present invention also allows for a third audio program to be accessed, namely, the sounds that are taking place on the court. So, for example, a user will have a choice of hearing the announcers, the SAP channel, or the natural court sounds without an announcer, if desired. FIG. 4B illustrates screen 400 with only score 402 displayed, and not score 404.

Scoreboard

FIG. 4C illustrates the scoreboard 406 and a cursor 408 that is selectable from remote control 224. Scoreboard 406 is accessed from either screen 300 or screen 400 as a semi-transparent overlay. Scoreboard 406 shows all of the day's matches. The viewer can use buttons on the remote control 224 to access cursor 408 to change the display between Women's, Men's, and Doubles' results or matches in progress, and can use other buttons on remote control 224 to “page” through the scores as indicated by page counter 410. For each match, the names of the players, seedings, serve indicator, game score, and set scores are shown. For matches that are complete, the winner will be indicated as well. Using the yellow button 240 from the scoreboard 406 will clear the scoreboard 406.

Broadcast Center Control

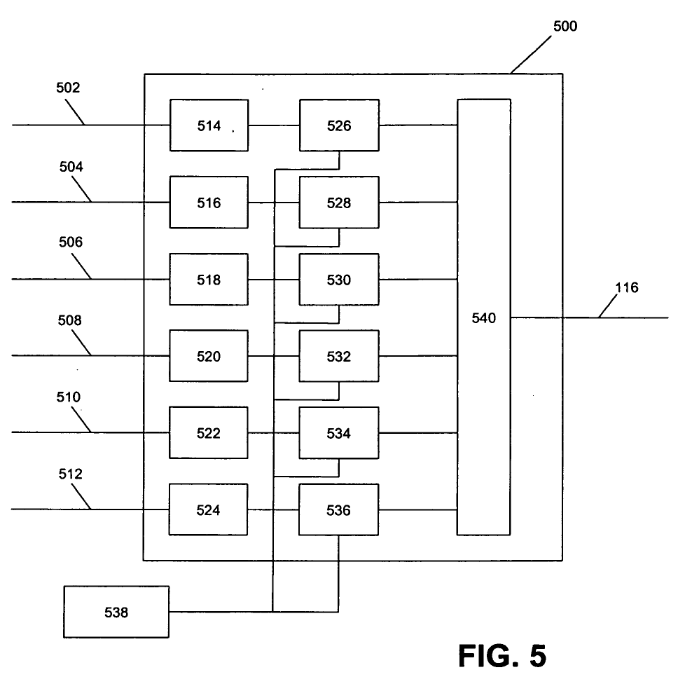

FIG. 5 illustrates a block diagram of the control for commercial spots in accordance with the present invention.

Broadcast center 500 receives broadcast feed 502, and several other programming feeds 504-512. A larger or smaller number of programming feeds 504-512 can be used without departing from the scope of the present invention.

Encoders 514-524 encode Selection Identification (SID) information into the program stream on broadcast feed 502 and programming feeds 504-512 respectively. Since programming feeds 504-512 may contain information that is not always associated with broadcast feed 502, encoders 516-124 may encode a different SID on programming feeds 504-512 at different times.

Each SID is associated with a program. So, for example, the U.S. Open Tennis tournament programming on USA Network is a program, and, as such, received a unique SID that is encoded by encoder 514. However, since a service provider is making additional U.S. Open coverage available during certain portions of the U.S. Open USA Network television coverage, the unique SID is also assigned to those programming feeds 504-512 that are associated with the U.S. Open coverage being broadcast on broadcast feed 502. When a Nielsen ratings box, coupled to monitor 114 or IRD 112, detects the SID, the program associated with that SID is given “credit” in the Nielsen system for viewership.

However, since each of the broadcast feed 502 and programming feeds 504-512 are separate events, commercial advertising spots must be inserted at proper places within each of the feeds 502-512. Ad playout servers 526-536 are placed in each of the feeds 502-512 such that each of the servers 526-536 can be supplied with commercial spots 538 to be inserted into the feeds 502-512 at the proper time. As such, the commercials for each of the feeds 502-512 will be receiving the same commercial spots 538, however, each feed 502-512 may receive a given commercial spot at different times.

For example, and not by way of limitation, broadcast feed 502 may be at a point in the program for a commercial spot, and the ad playout server 526 will insert a commercial at this time. Simultaneously, programming feed 504 may not be at a point where a commercial insertion would be appropriate, however, for proper advertising purposes, the commercial spot must be played on programming feed 504. Ad playout server 528 will allow for insertion of the commercial spot at a later time, or at an earlier time, on feed 504 than on feed 502.

For example, and not by way of example, a popular tennis player may be playing on center court, and, most likely, the match involving the popular player will be broadcast on broadcast feed 502. However, there are also other matches taking place simultaneously that may be of interest to viewers, and, as such, programming feeds 504-512 may be carrying coverage of those matches. When the viewer watches the mix channel screen 300, and changes to a court channel 400 that is not the broadcast feed 502, e.g., programming feed 504, the SID for broadcast channel 502 is assigned to programming feed 504 such that any Nielsen rating box that decodes the SID properly allocates viewership credit to the viewers watching programming feed 504 rather than broadcast feed 502. Since the SID is assigned to a program, in this case, the U.S. Open on USA Network, rather than a channel, this aggregation is allowable and required for proper statistical purposes.

By inserting the identical commercial inventory 538 on the multiple video program streams, i.e., feeds 502-512, and encoding each of those streams with the identical SID via encoders 514-524, Nielsen can aggregate the ratings of the individual program feeds 502-512 into a parent program rating and delivering that single program rating to the program provider.

After insertion of the SID and commercials at the proper time for each of the feeds 502-512, the feeds are aggregated in combiner 540 and sent to satellites via signal 116. The individual feeds 502-512 represent the video, audio, metadata, and other information that is used to display video cells 202A-202F on monitor 114.

Conclusion

The present invention comprises an interactive matrixed video channel displayed on a video monitor. A channel in accordance with the present invention has a plurality of individual video feeds being presented at a given time and comprises a plurality of video cells presenting at least video information, each video cell associated with one of the plurality of individual video feeds, each video cell further comprising an area within the video cell reporting data related to the video feed, and a cursor, which can be moved between the plurality of video cells, for selecting an audio program associated with a selected video cell, wherein the audio program is selected from a group comprising a broadcast audio program, a second audio program, and a live audio program.

Such an interactive matrixed video channel further optionally comprises the user selecting a video program associated with the selected video cell such that a secondary video cell is displayed, comprising at least the selected video program, the secondary video cell further comprising displaying at least the data related to the video information in the video feed, an overlay screen, which is selectively overlayed on at least one of the matrixed video channel and the secondary video cell, wherein the overlay screen comprises data related to the video information in the video feed, the overlay screen being displayed in response to a user selection on a remote control, the data related to the video feed toggles between an overall data display and a current data display, and the data toggles based on a user selection on a remote control.

An apparatus in accordance with the present invention displays a mosaic video channel, wherein the mosaic video channel has a plurality of video cells being presented at a given time, comprises a broadcast delivery system, comprising a transmitter and a receiver, a monitor, coupled to the receiver, for selectively displaying the mosaic video channel, each video cell associated with one of a plurality of individual video feeds, and a cursor, displayed on the monitor, which is movable between the plurality of video cells, for selecting an audio program associated with a selected video cell, wherein the audio program is selected from a group comprising a broadcast audio program, a second audio program, and a live audio program.

Such an apparatus further optionally comprises the broadcast delivery system being a satellite television delivery system, a plurality of mosaic video channels, when the user selects a video program associated with the selected video cell, a secondary video cell is displayed which comprises at least the selected video program, the secondary video cell further comprising displaying at least the data related to the video information in the video feed, an overlay screen, which is selectively overlayed on at least one of the matrixed video channel and the secondary video cell, wherein the overlay screen comprises data related to the video information in the video feed, and the overlay screen is displayed in response to a user selection on a remote control.

A system in accordance with the present invention selectively displays a video cell within a mosaic video channel having a plurality of video cells, and comprises a broadcast delivery system, comprising a transmitter and a receiver, a monitor, coupled to the receiver, for selectively displaying the mosaic video channel, each video cell associated with one of a plurality of individual video feeds, and a cursor, displayed on the monitor, which is movable between the plurality of video cells, for selecting an audio program associated with a selected video cell, wherein the audio program is selected from a group comprising a broadcast audio program, a second audio program, and a live audio program.

Such a system further optionally comprises the broadcast delivery system being a satellite television delivery system, when the user selects a video program associated with the selected video cell, a secondary video cell comprising at least the selected video program is displayed, the secondary video cell further comprises displaying at least the data related to the video information in the video feed, an overlay screen, which is selectively overlayed on at least one of the matrixed video channel and the secondary video cell, wherein the overlay screen comprises data related to the video information in the video feed, and the overlay screen is displayed in response to a user selection on a remote control.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description.

What is claimed is:

1. An interactive matrixed video channel displayed on a video monitor, with a plurality of individual video feeds being presented at a given time, comprising:
a plurality of video cells presenting at least video information, each video cell associated with one of the plurality of individual video feeds, each video cell further comprising an area within the video cell reporting data related to the video feed; and
a cursor, which can be moved between the plurality of video cells, for selecting an audio program associated with a selected video cell, wherein the audio program is selected from a group comprising a broadcast audio program, a second audio program, and a live audio program.

2. The interactive matrixed video channel of claim 1, wherein when the user selects a video program associated with the selected video cell, a secondary video cell is displayed, comprising at least the selected video program.

3. The interactive matrixed channel of claim 2, wherein the secondary video cell further comprises displaying at least the data related to the video information in the video feed.

4. The interactive matrixed channel of claim 3, further comprising an overlay screen, which is selectively overlayed on at least one of the matrixed video channel and the secondary video cell, wherein the overlay screen comprises data related to the video information in the video feed.

5. The interactive matrixed channel of claim 4, wherein the overlay screen is displayed in response to a user selection on a remote control.

6. The interactive matrixed channel of claim 1, wherein the data related to the video feed toggles between an overall data display and a current data display.

7. The interactive matrixed channel of claim 6, wherein the data toggles based on a user selection on a remote control.

8. An apparatus for displaying a mosaic video channel, the mosaic video channel having a plurality of video cells being presented at a given time, comprising:
a broadcast delivery system, comprising a transmitter and a receiver;
a monitor, coupled to the receiver, for selectively displaying the mosaic video channel, each video cell associated with one of a plurality of individual video feeds; and
a cursor, displayed on the monitor, which is movable between the plurality of video cells, for selecting an audio program associated with a selected video cell, wherein the audio program is selected from a group comprising a broadcast audio program, a second audio program, and a live audio program.

9. The apparatus of claim 8, wherein the broadcast delivery system is a satellite television delivery system.

10. The apparatus of claim 9, further comprising a plurality of mosaic video channels.

11. The apparatus of claim 10, wherein when the user selects a video program associated with the selected video cell, a secondary video cell is displayed, comprising at least the selected video program.

12. The apparatus of claim 11, wherein the secondary video cell further comprises displaying at least the data related to the video information in the video feed.

13. The apparatus of claim 12, further comprising an overlay screen, which is selectively overlayed on at least one of the matrixed video channel and the secondary video cell, wherein the overlay screen comprises data related to the video information in the video feed.

14. The apparatus of claim 13, wherein the overlay screen is displayed in response to a user selection on a remote control.

15. A system for selectively displaying a video cell within a mosaic video channel having a plurality of video cells, comprising:
a broadcast delivery system, comprising a transmitter and a receiver;
a monitor, coupled to the receiver, for selectively displaying the mosaic video channel, each video cell associated with one of a plurality of individual video feeds; and
a cursor, displayed on the monitor, which is movable between the plurality of video cells, for selecting an audio program associated with a selected video cell, wherein the audio program is selected from a group comprising a broadcast audio program, a second audio program, and a live audio program.

16. The system of claim 15, wherein the broadcast delivery system is a satellite television delivery system.

17. The system of claim 16, wherein when the user selects a video program associated with the selected video cell, a secondary video cell is displayed, comprising at least the selected video program.

18. The system of claim 17, wherein the secondary video cell further comprises displaying at least the data related to the video information in the video feed.

19. The system of claim 18, further comprising an overlay screen, which is selectively overlayed on at least one of the matrixed video channel and the secondary video cell, wherein the overlay screen comprises data related to the video information in the video feed.

20. The system of claim 19, wherein the overlay screen is displayed in response to a user selection on a remote control.
